(19) United States
(12) Patent Application Publication
(10) Pub. No.: US 2008/0170741 A1
(43) Pub. Date: Jul. 17, 2008

(54) Convenient electronic sound producing device

(76) Inventor: Edward J. Sceery, Santa Fe, NM (US)

Correspondence Address: Richard H. Krukar;Ortiz & Lopez, PLLC, P.O. Box 4484, Albuquerque, NM, 87196-4484, US

(21) Appl. No.: 11/652,328

(22) Filed: Jan. 11, 2007

(51) Int. Cl. H04R 1/02

(52) U.S. Cl. 381/387

(57) ABSTRACT

A convenient electronic sound producing device is an electronic sound producing device that is physically configured to be easy to use in the field. A control module faces the use while the sound is projected away from the user. A pistol grip can be used to ease holding and using the call. A remote can further ease operation and allow control from a distance. A timer allows for nearly autonomous operation. Control modules can be fixed to a firearm, bow, crossbow, or camera to minimize the user's movement while simultaneously calling and preparing for a shot. A pinning hole or a stake can allow for reliably fixing the sound producing device to a surface, to vegetation, or to other objects.

### TECHNICAL FIELD

Embodiments relate to game calls, sound producing devices, digital audio devices, and remote controls. Embodiments also relate to hunting, wildlife observation, and wildlife vocalizations.

### BACKGROUND OF THE INVENTION

People have made and used sound producing devices to produce sounds since prehistoric times and continue to make and use them. Sounds are produced for a variety of purposes. Call sounds are sounds whose purpose is to entice an animal to respond, usually by coming closer. Over time, sound production technology has changed while the purposes have largely remained the same.

A caller uses a sound producing device to produce a call sound. In general, the call sound is an attractive sound such as an imitation of an animal vocalization. Different call sounds are appropriate for enticing different animals. For example, elk can respond to any of a variety of elk vocalizations or other attractive sounds such as antlers thrashing in brush. Similarly, turkey can respond to any of a variety of turkey vocalizations or other attractive sounds such as beating wings. Predators, such as coyotes, often respond to prey animal vocalizations such as those of a distressed rabbit.

Individual animals, like individual people, can have different voices. As such, a caller can attempt to produce vocalizations corresponding to different individuals. Furthermore, as discussed above, call sounds are not limited to vocalizations. For example, deer and elk are often attracted to the sound of antlers tossing in foliage or of a feeding bin being filled.

As can be inferred, the number of call sounds that might possibly attract a particular animal is large but the number that actually does attract the animal is usually much smaller. Hunters have learned to produce many call sounds in the hope that one of them will work.

Recent technological advances have led to electronic sound producing devices such as the electronic game call. An electronic game call stores many different call sounds. A user can select a call sound and play it. Current electronic game calls, however, are not physically well suited to field use. A need therefore exists for a convenient electronic sound producing device for imitating animal sounds.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments for a speaker to produce a call sound from a call signal. An electronics module outputs the call signal and has inputs including control signals and an actuator signal. The electronics module also has access to electronically stored data corresponding to each call sound. For example, a non-volatile memory can store digitized call sounds, much like digital music players store digitized music. The electronics module can access the digitized call sounds stored in the non-volatile memory.

It is also an aspect of the embodiments that a control module produces the control signals. The control module has selectors, such as buttons, for selecting call sounds and has indicators, such as light emitting diodes, for indicating which call is currently selected. A user can select a call sound using the selectors and can observe the indicators to determine which call sound is selected. The control module produces the control signals based on the selectors. The control signals tell the electronics module which call signal to produce.

It is another aspect of the embodiments that an actuator produces the actuation signal. The actuator can be a button that is pressed to produce the actuator signal, can be a trigger that is squeezed to produce the actuation signal, or can be any other actuator. The selectors on the control module can also act as actuators such that making a selection results in control signals and in an actuation signal. It is possible for the same signal to act as a control signal and as an actuation signal. The electronics module produces the call signal upon receiving the actuation signal.

It is a further aspect of the embodiments that a housing holds, protects, and contains many sound producing device parts such as the speaker, control module, and electronics module. The housing has a front and a back. The control module is in the back and the speaker is in the front. In normal operation, a user holding the sound producing device can see the control module while the speaker emits call sounds in a forward direction away from the user. The housing can also have a pistol grip that the user holds.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates a sound producing device in accordance with aspects of the embodiments;

FIG. 2 illustrates a user using a sound producing device in accordance with aspects of the embodiments;

FIG. 3 illustrates a control module in accordance with aspects of the embodiments;

FIG. 4 illustrates a base in accordance with aspects of the embodiments;

FIG. 5 illustrates speaker ports in a housing in accordance with aspects of the embodiments;

FIG. 6 illustrates a remote in accordance with aspects of some embodiments;

FIG. 7 illustrates a high level block diagram of a sound producing device in accordance with aspects of the embodiments;

FIG. 8 illustrates a firearm configured for use with a sound producing device in accordance with aspects of certain embodiments;

FIG. 9 illustrates a side view of using a hook in a pinning hole in accordance with aspects of some embodiments; and

FIG. 10 illustrates a front view of using a hook in a pinning hole in accordance with aspects of some embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

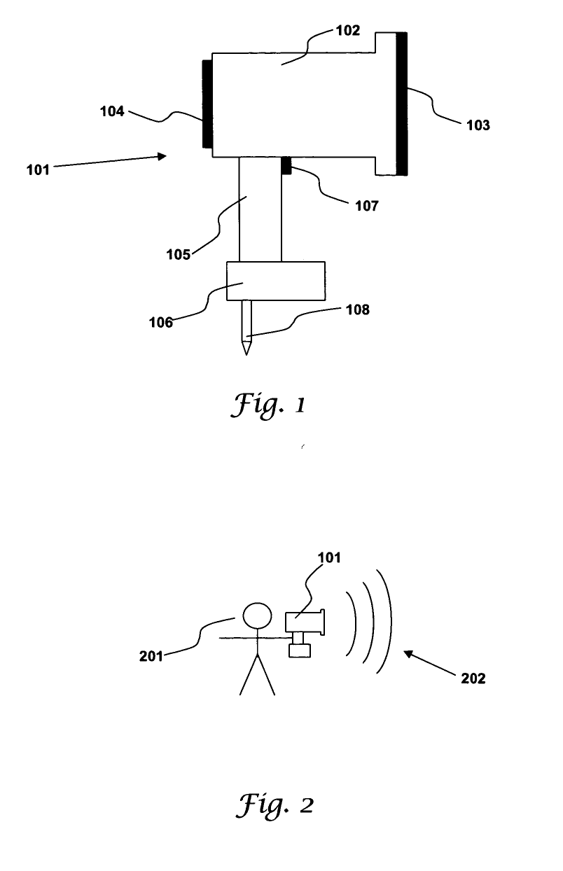

FIG. 1 illustrates a sound producing device 101 in accordance with aspects of the embodiments. A housing 102 has a control module 104 mounted in back and a speaker 103 mounted in front. The housing 102 is illustrated as having a pistol grip 105 and a base 106. A trigger type actuator 107 is mounted to the housing 102 such that a user holding the pistol grip 105 can squeeze it. A deployable spike 108 is shown extending from the bottom of the base. The deployable spike 108 is not fixed in place but can be removed. In some embodiments, the deployable spike 108 can be stored within the housing 102 and can be deployed by a user. The deployable spike 108 is used to fix the sound producing device 101 in place. For example, the deployable spike 108 can be driven into the ground so that the sound producing device 101 is fixed in place on the ground.

FIG. 2 illustrates a user 201 using a sound producing device 101 in accordance with aspects of the embodiments. The user 201 is holding the pistol grip and squeezing the actuator. The sound producing device 101 is producing a call sound 202. Notice that the user 201 is looking at the control module on the back of the housing and that the call sound is emitted from the front of the housing. A spike such as that illustrated in FIG. 1 is not illustrated as deployed in FIG. 2.

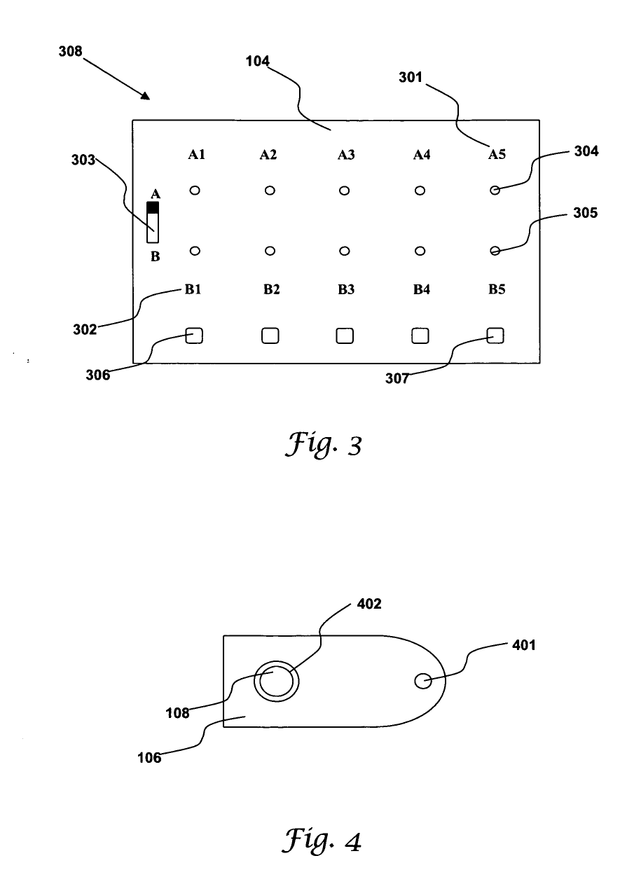

FIG. 3 illustrates a control module 104 in accordance with aspects of the embodiments. The control module 104 has a control layout 308 that specifies the positions of labels, indicators, and buttons. As such, the control module 104 has two label rows, each row having five labels. The control module 104 also has two indicator rows, each having five indicators. The top label row has labels such as “A5” 301. The labels used are intended to indicate where labels can be positioned. In practice, the labels can be “coyote howl”, “distressed rabbit”, “cat howl”, or any other call name. The top indicator row has indicators such as the “A5” indicator 304. A light emitting diode (LED) can be used as an indicator. The lower label row is illustrated as positioned under the lower indicator row and containing labels such as “B1”. The lower indicator row contains indicators such as the “B5” indicator 305.

A selector row can contain buttons such as the leftmost button 306. A bank selector 303 can be used to select the top row or the bottom row. The bank selector 303 is illustrated as selecting the top row. Pressing the rightmost button 307 with the bank selector 303 in the top position selects call sound “A5” and the “A5” indicator 301 lights up.

Multifunction indicators, such as multifunction LEDs can also be used. A multifunction LED can display two or more colors. For example, a control module can have two label rows and a multifunction LED row. In this case the “A5” indicator 304 becomes the “A5/B5” indicator 304 and the “B5” indicator does not exist. A red “A5/B5” indictor 304 can indicate that call sound “A5” is selected whereas a green “A5/B5” indictor 304 can indicate that call sound “B5” is selected.

FIG. 4 illustrates a base 106 in accordance with aspects of the embodiments. The deployable spike 108 is illustrated mounted in a spike hole 402 in the base. A pinning hole 401 in the base 106 can be used in a number of ways. The pinning hole 401 can be used to hang the sound producing device from a tree branch, in which case the sound producing device would be up side down. A nail or pin through the pinning hole 401 can fix the sound producing device to another object, such as a tree or the ground. A cord can be threaded through the pinning hole 401 and tied to something or used to hang the sound producing device from a tree branch.

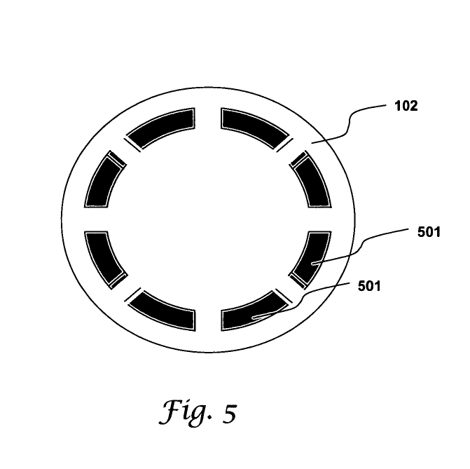

FIG. 5 illustrates speaker ports 501 in a housing 102 in accordance with aspects of the embodiments. Those practiced in the arts of acoustics or speaker enclosures are familiar with systems and methods for using speaker ports to improve the sound of a speaker.

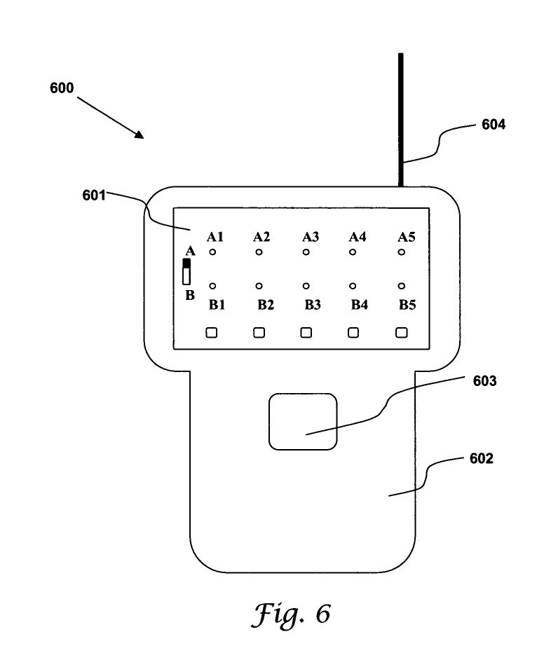

FIG. 6 illustrates a remote 600 in accordance with aspects of some embodiments. The remote 600 has a remote housing 602 and a remote control module 601. Notice that the remote control module 601 and the control module illustrated in FIG. 3 have the same configuration of labels, indicators, selectors, and bank selector. It is advantageous for the control module and the remote control module 601 to look the same and be operated the same because a user who can use one can immediately use the other without additional instruction. The remote 600 also has a remote actuator 603.

The remote 600 can communicate with the sound producing device such that remote operations are equivalent to directly operating the sound producing device. For example, pressing the remote actuator can cause a remote output signal corresponding to actuation to be sent to the sound producing device that then reacts as if the actuator was pulled. Similarly, selecting a call remotely can cause a remote output signal corresponding to call selection to be sent to the sound producing device that then reacts as if the control module were used to select a call. For example, a user can select call “A4” on the remote 600. The remote's “A4” indicator is lit in response and a remote output signal is transmitted. The sound producing device receives the remote output signal, selects the “A4” call, and lights the sound producing device's “A4” indicator. If the sound producing device plays a call sound on selection, then the sound producing device can also play a call sound on remote selection.

The placement of the control module on the back of the sound producing device allows the user to observe it from a distance while directing call sounds in a forward direction. In practice, a user can position the sound producing device and then move back from it. The user can remotely select calls and see the reaction on the control module. As such, the user is confident that remote operation is working reliably.

The sound producing device and the remote can be kept in synchronization if the sound producing device can send a call output signal to the remote. One example of synchronization is that when a user selects a call sound on the remote, the remote sends a remote output signal to the sound producing device. The sound producing device responds by selecting the desired call sound, lighting the appropriate indicator on the control module, and sending a call output signal to the remote. The remote responds by lighting the appropriate indicator on the remote control module. A second example is when the user uses the control module to select a call sound. The sound producing device responds by lighting the appropriate indicator on the control module and sending a call output signal to the remote. The remote responds by lighting the appropriate indicator on the remote control module.

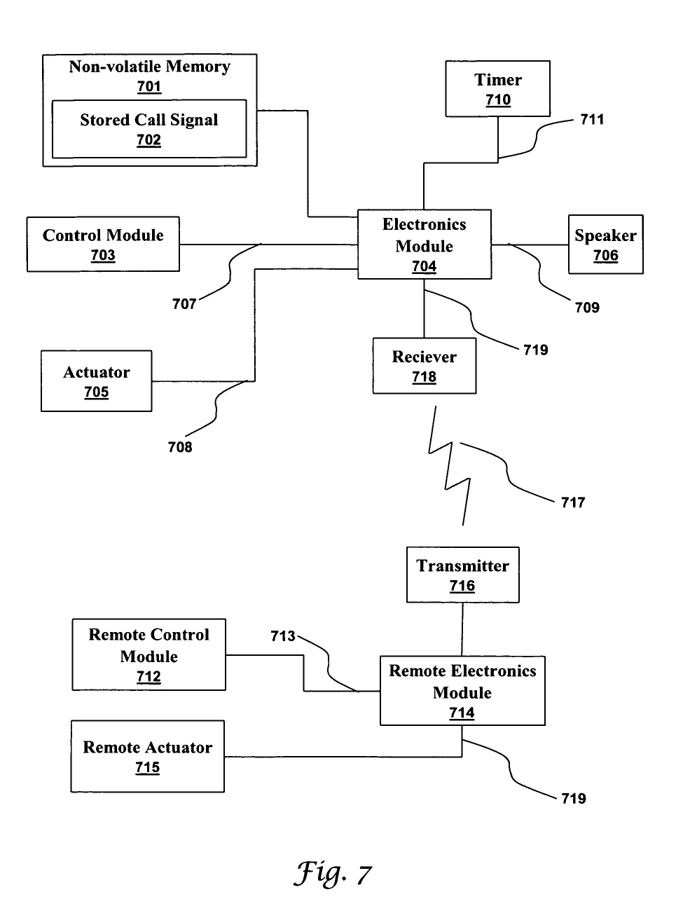

FIG. 7 illustrates a high level block diagram of a sound producing device in accordance with aspects of the embodiments. Non-volatile memory 701, such as a flash memory, read only memory, or magnetic disk can contain at least one stored call signal 702. An electronics module 704 can access the stored call signal 702. A control module 703 and the electronics module 704 use control signals 707 to communicate. An actuator 705 sends an actuation signal 708 to the electronics module 704. The electronics module 704 obtains one of the possibly many stored call signals 702 based on the control signals 707. On receiving the actuation signal 708, the electronics module 704 sends a call signal 709 to the speaker 706. The speaker 706 then produces a call sound.

A timer 710 can be used to trigger periodic call sounds. The user can use a timer control interface on the control module 703 or remote control module 712 to select a time interval. Those practiced in setting alarm clocks, cooking timers, watches, or similar devices are familiar with timer control interfaces. The timer 710 can repeatedly produce a timed actuation signal 711 each time the time interval elapses. As such, the timer can count down until the time interval ends and then automatically reset and begin counting down again. The electronics module reacts to the timed actuation signal by sending the call signal 709 to the speaker 706.

A remote can contain a remote control module 712, transmitter 716, and remote electronics module 714. The remote control module 712 and the remote electronics module 714 can use remote electronic module inputs 713 to communicate. The remote electronics module 714 then sends a remote output signal to a remote communicator 716, such as a radio, that transmits it to a call communicator 718 from which the remote output signal goes to the electronics module 704. As such, the electronics module 704 can react to the remote control module 712 in the same way it would react to the control module 703. Similarly, a remote actuator 715 sends a remote actuation signal 719 to the remote electronics module 714 such that, eventually, the electronics module 704 reacts by producing the call signal 709.

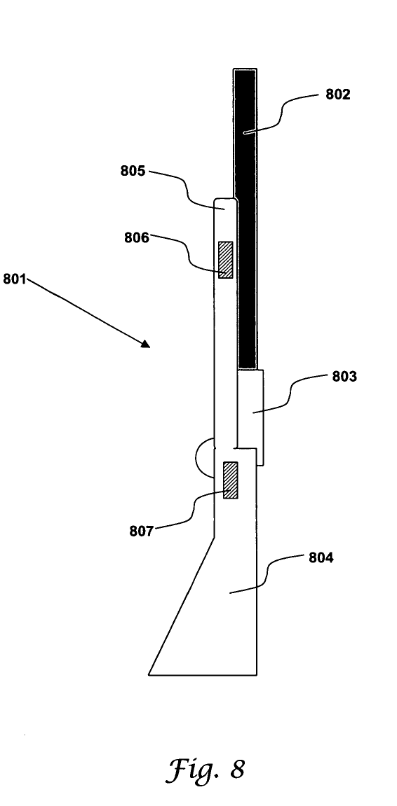

FIG. 8 illustrates a firearm 801 configured for use with a sound producing device in accordance with aspects of certain embodiments. The firearm 801 has a barrel 802, action 803, and stock 804. A forward interface 806 is attached to the fore stock 805, which is the front part of the stock 804. A back interface 807 is located near the action 803. While aiming the firearm 801, a user can manipulate the forward interface 806 with one hand or the back interface 807 with the other hand. The front interface 806 can have a remote actuator, a remote control module, or both. The back interface 807 can also have a remote actuator, a remote control module, or both. The firearm 801 is illustrated with both a front interface 806 and back interface 807 although in practice only one interface is used. A bow, crossbow, or camera can also be configured with an interface such as the back interface 807 or front interface 806. A fastener, such as glue, adhesive, or Velcro can be used for attaching interface.

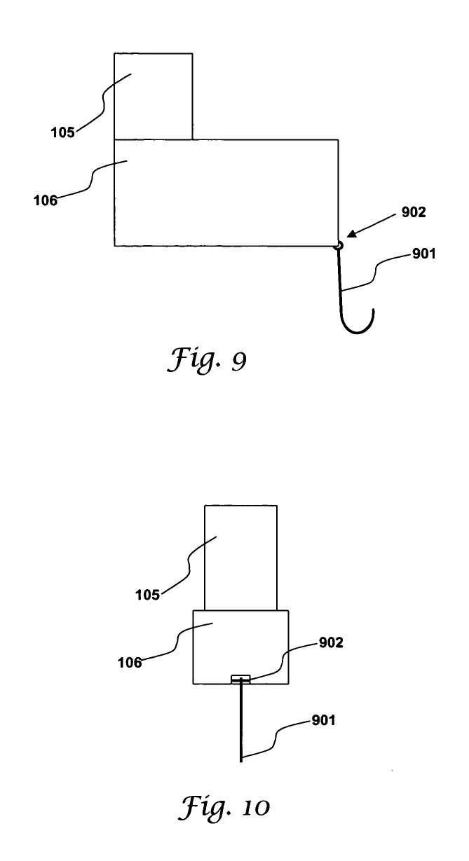

FIG. 9 illustrates a side view of using a hook in a pinning hole in accordance with aspects of some embodiments. The lower portion of a pistol grip 105 is connected to a base having a pinning hole 902. A hook 901 is attached to the pinning hole 902. The sound producing device can be hung by the hook. Other hanging means, such as cords, carabiners, or wire can be used instead of the hook.

FIG. 10 illustrates a front view of using a hook in a pinning hole in accordance with aspects of some embodiments. The lower portion of a pistol grip 105 is connected to a base having a pinning hole 902. A hook 901 is attached to the pinning hole 902. In this embodiment, unlike that illustrated in FIG. 4, the pinning hole 902 does not pass from the top of the base to the bottom of the base. Instead, it passes from the front of the base to the bottom of the base. In other embodiments, the pinning hole can be positioned anywhere on the housing.

The examples discussed above are intended to illustrate aspects of the embodiments. The phrases “an embodiment”, “some embodiments”, or “certain embodiments” do not necessarily refer to the same embodiment or any specific embodiment.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising:
a speaker that produces a call sound from a call signal;
a control module that produces at least one control signal;
a housing comprising a front and a back wherein the speaker is mounted in the front, and wherein the control module is mounted in the back;
an actuator wherein a user triggers the actuator to produce an actuation signal; and
an electronics module inside the housing wherein the electronic module accepts the at least one control signal and the actuation signal and wherein the electronic module produces the call signal.

2. The system of claim 1 further comprising:
a remote comprising a remote control housing, a remote control module, and a remote electronic module;
wherein the remote control module produces at least one remote electronic module input;
wherein the remote electronics module accepts the at least one remote electronic module input and sends at least one remote output signal; and
wherein the electronics module accepts the at least one remote output signal and uses the at least one remote output signal to produce the call signal.

3. The system of claim 2 wherein the remote control module and the control module share a control layout.

4. The system of claim 1 wherein the housing comprises at least one speaker port.

5. The system of claim 1 wherein the control module comprises at least two LEDs that are used to indicate a call selection.

6. The system of claim 1 wherein the control module comprises at least two multifunction LEDS that are used to indicate a call selection.

7. The system of claim 1 further comprising a timer that produces a timed actuation signal that triggers the electronics module to produce the call signal.

8. A system comprising:
a speaker that produces a call sound from a call signal;
a control module that produces at least one control signal;
a housing comprising a front, a back, and a pistol grip wherein the speaker is mounted in the front, and wherein the control module is mounted in the back;
an actuator wherein a user squeezes the actuator to produce an actuation signal and wherein the actuator is positioned forward of the pistol grip such that a user can use one hand to hold the pistol grip and squeeze the actuator;
an electronics module inside the housing wherein the electronic module accepts the at least one control signal and the actuation signal and wherein the electronic module produces the call signal.

9. The system of claim 8 further comprising:
a remote comprising a remote control housing, a remote control module, and a remote electronic module;
wherein the remote control module produces at least one remote electronic module input;
wherein the remote electronics module accepts the at least one remote electronic module input and sends at least one remote output signal; and
wherein the electronics module accepts the at least one remote output signal and uses the at least one remote output signal to produce the call signal.

10. The system of claim 9 wherein the remote control module and the control module share a control layout.

11. The system of claim 8 wherein the housing comprises at least one speaker port.

12. The system of claim 8 wherein the control module comprises at least two LEDs that are used to indicate a call selection.

13. The system of claim 8 wherein the control module comprises at least two multifunction LEDs that are used to indicate a call selection.

14. The system of claim 8 further comprising a timer that produces a timed actuation signal that triggers the electronics module to produce the call signal.

15. The system of claim 8 wherein the housing further comprises a pinning hole.

16. The system of claim 8 further comprising a deployable stake wherein the housing holds the stake in either a deployed position or a stashed position.

17. The system of claim 8 further comprising:
a remote comprising a remote control housing, a remote control module, and a remote electronic module wherein the remote control module and the control module share a control layout;
a timer that produces a timed actuation signal that triggers the electronics module to produce the call signal;
a deployable stake wherein the housing holds the stake in either a deployed position or a stashed position;
wherein the remote control module produces at least one remote electronic module input;
wherein the remote electronics module accepts the at least one remote electronic module input and sends at least one remote output signal;
wherein the electronics module accepts the at least one remote output signal and uses the at least one remote output signal to produce the call signal
wherein the housing comprises at least one speaker port;
wherein the control module comprises at least to multifunction LEDs that are used to indicate a call selection; and
wherein the housing further comprises a pinning hole.

18. A system comprising:
a speaker that produces a call sound from a call signal;
a control module that produces at least one control signal;
a speaker mounted in a housing;
an actuator wherein a user triggers the actuator to produce an actuation signal; and
an electronics module inside the housing wherein the electronics module accepts the at least one control signal and the actuation signal and wherein the electronic module produces the call signal.

19. The system of claim 18 further comprising a weapon wherein the actuator is attached to the weapon such that the user can simultaneously trigger the actuator and use the weapon.

20. The system of claim 18 further comprising a weapon wherein the control module is attached to the weapon such that the user can simultaneously manipulate the control module and use the weapon.
